(19) United States
(12) Patent Application Publication
(10) Pub. No.: US 2004/0129152 A1
(43) Pub. Date: Jul. 8, 2004

(54) Method to produce a print block for rotogravure

(76) Inventor: Siegfried Beisswenger, Preetz (DE)

Correspondence Address: SCHIFF HARDIN, LLP, PATENT DEPARTMENT, 6600 SEARS TOWER, CHICAGO, IL, 60606-6473, US

(21) Appl. No.: 10/667,822

(22) Filed: Sep. 22, 2003

(30) Foreign Application Priority Data
Oct. 17, 2002 (DE) 102 48 602.6
May 27, 2003 (DE) 103 24 327.5

(51) Int. Cl. B41N 1/06

(52) U.S. Cl. 101/150

(57) ABSTRACT

In a rotogravure print block, and a method to produce a print block, by use of a laser beam engraving cups are generated in an engraving surface. Before the laser beam engraving, a chromium layer is applied to the print block as the engraving surface.

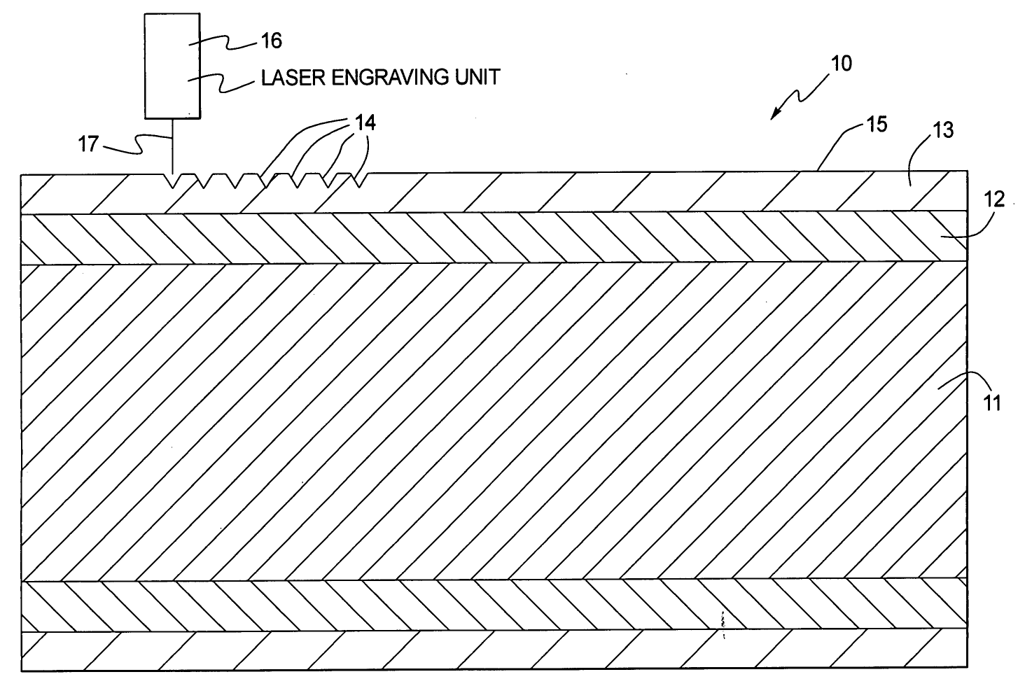

### BACKGROUND OF THE INVENTION

The invention generally relates to a method to produce a print block for rotogravure, such as in one example, heliorotogravure, whereby cups are generated in an engraving surface by means of a laser beam engraving, as well as a print block for rotogravure, such as, for example, heliorotogravure, with an engraving surface for laser engraving of cups.

Also, the invention generally relates to a print block for rotogravure, for example heliorotogravure, whereby cups can be generated in an engraving surface by means of a laser beam engraving.

Print blocks for rotogravure, also called print cylinders or engraving cylinders, are predominantly produced in engraving devices by means of a recording unit in the form of an engraving unit, or by means of an electron beam or laser beam.

A master to be reproduced is scanned with a scanning unit point-by-point and line-by-line in order to acquire an image signal which represents the tone values of the scanned master. The image signal is corrected according to the requirements of the reproduction (for example according to a predetermined gradation curve) and is superimposed on a raster signal to generate the print raster. The recording signal formed by the superimposition of the image signal and the raster signal controls the recording unit which moves in the axial direction along the print cylinder and engraves a sequence of depressions or recesses (called cups) arranged in the print raster into the generated surface of the print cylinder. The scanning of the master that follows the principle given above occurs today as a rule only with electronic scanning of the master. The image data provided by the scanning are given to a computer in which a program-aided conversion and processing occurs. The computer then provides the image signals, on the basis of which the cups were designed, either mechanically and/or by means of laser engraving in the generated surface of the print cylinder. The depths or, respectively, volumes of the engraved cups determines the tone value to be printed between “black” and “white”, also indicated in print technology terminology with “dark” and “light”.

For the print process, the engraved print cylinder is then mounted in a rotogravure rotation machine. Before the print event, each cup accepts a quantity of printing ink, dependent on its volume, that corresponds to the tone value to be printed. In the print event, the ink transfer then occurs from the cups to the print material.

A rotogravure cylinder common in practice is in general comprised of a steel core that can additionally be provided with a base copper layer. A further copper layer in which the cups are engraved is galvanized on the steel core or the base copper layer. Due to its physical and chemical properties, copper exhibits good engraving properties as well as good ink acceptance and ink transfer properties, which aids the generation of high-quality prints. The thickness of the galvanically applied copper engraving surface is approximately 100 μm. Moreover, the copper layer to be engraved is polished, such that the surface is provided with a defined micro-roughness. The information to be printed from the image and written is subsequently placed in the form of a fine cup-raster onto the copper surface in a mechanical manner by means of a diamond engraving tool.

However, what is disadvantageous in the use of copper as an engraving material is that it exhibits a relatively low hardness. Wear that reduces the print quality as well as the service life of the print cylinder thereby occurs in the printing process in the rotogravure rotation machine as a result of the mechanical stress of the copper layer due to the scraping with increasing operation time period. This wear limits the layer strength. In order to improve the wear resistance of the engraved copper layer, and thus to increase the service life of the print cylinder, it is typical in practice before the proof to degrease and subsequently to provide via galvanization a wear-resistant layer made of a metal harder than copper, for example made of chromium. The chromium surface is polished before the finished print block is inserted into the print machine.

After the printing, the chromium layer, as well as the copper layer underneath containing the engraving, is chemically or mechanically removed. The print cylinder is thereby available for a new cycle to produce another print block.

Furthermore, in the past in rotogravure print blocks were produced by means of etching, which had led to good results. The print cylinder was covered with a mask layer, whereby a photographic exposure of the mask over film patterns, the rinsing away of the mask, and the etching of the copper surface with iron chloride subsequently occurred. What were disadvantageous were the lower process safety and the insufficiently good depiction of half tones for images. The etching methods were further changed in that the mask layer was exposed with a laser beam. This modified method was not only elaborate and expensive, but rather also had the disadvantages of the etching method, namely that the half tones for images could be poorly depicted.

It is furthermore known for generation of the cups on a print cylinder to use an applied electron beam engraving method in the material processing that has shown very good results due to the high energy of the electron beam and the enormous precision with regard to the beam deflection and beam geometry. The cups are thus fired in the copper layer at high speed with an electron beam of high power density. Due to the great complexity and the high investment costs for an electron beam engraving machine, electron beam engraving is not yet used in practice for the engraving of copper cylinders for rotogravure, but rather only in the steel industry for surface engraving of what are known as texture rollers for steel production, with which textures are rolled into the sheets.

Furthermore, it was attempted to use lasers for rotogravure engraving, in order to engrave the print cylinder with an outer copper layer by means of a laser. However, since copper is a very good reflector for laser radiation, very high capacities and in particular very high power densities are necessary for the laser to be used in order to melt the copper. In order to solve this problem, it was suggested to replace the copper layer that comprises the engraving with a zinc layer. The cups are thus fired into a zinc layer with a laser beam. The laser beam engraving of zinc requires overall less beam power than with copper. A substantial disadvantage of this method is that zinc is decidedly weaker than copper, and is not suitable as a surface material for print cylinders. A print cylinder with an engraving surface made of zinc therefore does not achieve approximately as long a service life in printing as a print cylinder with a surface made of copper. Print blocks with zinc surfaces are therefore not suitable for high print runs.

In order to increase the service life of a print cylinder with a zinc surface, it was suggested to chromium-plate the zinc surface after the engraving. But it is assumed in professional circles that the service lives that are achieved given normal copper cylinders are not realized with this. Furthermore, the problem exists that chromium does not bond to zinc as well as to copper, such that the combination of a zinc electroplating with a chromium electroplating is very complicated. It is therefore necessary to introduce further method steps. In addition to the difficult handling of zinc, disposal poses a further problem, in particular given the combination with chromium.

### SUMMARY OF THE INVENTION

It is an object of the present invention to provide a print block and a method to produce a print block such that durable good print results are achieved in rotogravure. The print block should be simple to produce, the expenditure for it should be kept as small as possible, and the print block should be suitable for engraving by means of a laser beam.

In accordance with the invention, a chromium layer is applied as an engraving layer onto the print block before the laser beam engraving.

### BRIEF DESCRIPTION OF THE DRAWINGS

The drawing FIGURE shows a sectional view of the rotogravure cylinder which is laser engraved to create a print block for rotogravure printing in a rotogravure printing machine.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

An advantage of the solution exists primarily in that, in place of the present engraving surface made of copper, an engraving surface made of chromium or a chromium alloy is used. Surprisingly, it has turned out that, given a laser beam engraving of a chromium layer, cups are generated with a higher efficiency than given a copper layer, although the thermodynamic data of chromium in comparison to copper could not have anticipated this at all. In the laser beam engraving, the generation of the cups occurs via a type of molten metal removal. For the cup generation, the corresponding metal volumes must be heated by the laser beam to the melting point, and the heat quantity is applied for phase transition in the melted material, in order to subsequently expel the molten material from the cups being generated in the engraving surface. The melting point of copper is approximately 1083° C. The melting point of chromium is approximately 1890° C. It emerges from the thermodynamic data for copper and chromium that an energy of 5,515 kJ is to be applied to melt 1 cm³ of metal given copper, and given chromium an energy of 8,698 kJ is to be applied. The higher efficiency given chromium arises due to the higher absorption given laser beams, dependent on the laser radiation used. Overall, the production process for rotogravure cylinders is significantly improved and simplified via the solution, since a longer service life in printing is achieved with the print block due to the harder properties of chromium. A further enhancement of the chromium layer, such as for example given copper, is therefore not necessary, such that further treatment processes of the engraving surface after the engraving of the cups are dispensed with. After completing the engraving by means of laser beams, the print block can thus immediately and directly be used in the printing machine, and indeed if necessary after a preceding trimming event. In principle, the trimming can even occur in the laser engraving. Thus overall, the production time for the generation of a print block or a print cylinder is significantly shortened.

As shown in the front sectional view of the drawing FIGURE, to form the print block engraving cylinder 10, a chromium layer 13 is galvanically applied. The galvanization normally occurs on a cylindrical steel core 11, a generated surface of which, in addition, can be provided with a base copper layer 12. The layer 13 made of chromium or a chromium alloy with a predetermined thickness, for example of approximately 25 μm, is applied via galvanization onto the steel core 11 or onto the base copper layer 12. A known chromium alloy is the chromium-vanadium alloy. A laser engraving unit 16 then engraves the cups 14 in layer 13 with a laser beam 17.

For this, it is advantageously provided that the chromium layer is provided with a predetermined roughness, in particular a micro-roughness. Due to this surface treatment, slight surface errors are eliminated.

The roughness is generated in a preferable manner by means of polishing and/or grinding.

According to an advantageous embodiment of the method, after the engraving the print block is inserted into a print machine, in particular a heliorotogravure, in order to print the printing material. In order to be able to use the print block again after the printing, the chromium layer after the printing is at least partially removed from the print block such that the print block, in particular the print cylinder, is repeatedly available for a new production cycle of the print block. The removal of the chromium layer can in particular occur via chemical or mechanical means.

The object is further achieved by a print block for rotogravure, in particular heliorotogravure, with an engraving surface for laser beam engraving of cups that is available via implementation of at least one method step of the previously specified method. The advantages that are achieved via the print block correspond substantially to the advantages that are cited above in connection with the described method.

Furthermore, the object is achieved via the use of a print block for rotogravure, in particular heliorotogravure, whereby by means of a laser beam engraving, cups can be generated in an engraving surface that is widely formed, in that a chromium layer is designed as an engraving surface.

In particular, the chromium layer is galvanically applied to the print block.

Furthermore, it is provided that the chromium layer is provided with a predetermined roughness, in particular a micro-roughness. In particular, the roughness is generated via polishing and/or grinding.

According to an advantageous development, after the engraving the print block is inserted into a printing machine, in particular a rotary printing machine.

Furthermore, after the printing the chromium layer is at least partially removed from the print block in a preferable manner. The advantages of the use of the print block arise from the preceding cited advantages.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A method for producing a print block for rotogravure, comprising the steps of:
applying a chromium layer to a print block as an engraving surface; and
by use of a laser beam, engraving cups in the chromium layer engraving surface.

2. The method according to claim 1 wherein the chromium layer is galvanically applied.

3. The method according to claim 1 wherein the chromium layer is provided with a predetermined roughness.

4. The method according to claim 3 wherein the roughness is generated by at least one of polishing and grinding.

5. The method according to claim 1 wherein the engraving is implemented with a plurality of at least one of simultaneous and successive laser beams.

6. A method for rotogravure printing, comprising the steps of:
providing a print block having a core;
applying a chromium containing layer on the print block core as an engraving surface;
laser beam engraving cups into the engraving layer; and
inserting the print block in a printing machine and printing by use of the print block.

7. The method according to claim 6 wherein after a completion of use in the printing machine, removing the chromium layer from the print block.

8. The method according to claim 6 including the step of providing the chromium layer with a predetermined roughness.

9. The method according to claim 8 wherein the roughness is generated by at least one of polishing and grinding.

10. The method according to claim 6 including the step of galvanically applying the chromium layer.

11. The method according to claim 6 including the step of providing a base copper layer on the core and then applying the chromium containing layer onto the base copper layer.

12. The method according to claim 6 wherein the core comprises steel.

13. The method according to claim 6 wherein the chromium layer comprises only chromium.

14. The method according to claim 6 wherein the chromium containing layer comprises a chromium alloy.

15. The method according to claim 6 wherein the chromium containing layer has a thickness of approximately 25 μn.

16. The method according to claim 6 wherein the rotogravure printing machine comprises heliorotogravure.

17. A method for producing a print block for rotogravure, comprising the steps of:
providing a cylindrical core;
galvanically applying a chromium layer to the copper layer as an engraving surface; and
by use of a laser beam, engraving cups in the chromium layer engraving surface.

18. A rotogravure print block, comprising:
a core;
a chromium layer over the core; and
laser engraved cups in the chromium layer.

19. The print block according to claim 18 wherein the core comprises steel and the chromium layer is galvanically applied directly on the steel.

20. The block according to claim 18 wherein a copper base layer is provided on the core and the chromium layer is applied on the base layer.

21. The block according to claim 18 wherein the chromium layer is provided with a predetermined roughness.

22. The block according to claim 18 wherein the chromium layer is only chromium.

23. The block according to claim 18 wherein the chromium layer comprises a chromium alloy.

24. The block according to claim 18 wherein the chromium has a thickness of approximately 25 μm.

25. A rotogravure print block, comprising:
a steel cylindrical core;
a copper layer on the core;
a chromium layer on the copper layer; and
laser engraved cups in the chromium layer.
